(19) United States
(12) Patent Application Publication
(10) Pub. No.: US 2009/0123668 A1
(43) Pub. Date: May 14, 2009

(54) MATERIALS AND CONFIGURATIONS FOR REDUCING WARPAGE IN OPTICAL FILMS

(75) Inventors: Timothy J. Hebrink, Oakdale, MN (US); Kevin M. Hamer, St. Paul, MN (US); Barry S. Rosell, Lake Elmo, MN (US); Joan M. Strobel, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/356,924

(22) Filed: Jan. 21, 2009

Related U.S. Application Data
(63) Continuation of application No. 10/427,422, filed on May 1, 2003, now abandoned.

(51) Int. Cl. C09K 19/00

(52) U.S. Cl. 428/1.5

(57) ABSTRACT

A multilayer optical body is disclosed and includes a light reflecting element formed from a first polymer material and a second polymer material having an index of refraction difference sufficient to reflect light of at least one polarization, and at least one non-optical warp-resistant layer disposed on the light reflecting element. The at least one non-optical one warp-resistant layer includes an intimate mixture of i) polystyrene or a first polystyrene copolymer and ii) a second polystyrene copolymer or ii) a polyester or copolyester.

### CROSS-REFERENCE TO RELATED APPLICATIONS

This application is a continuation application of co-pending U.S. patent application Ser. No. 10/427,422 filed on May 1, 2003, which is incorporated by reference herein.

### FIELD OF THE INVENTION

The present invention relates to optical bodies and methods of making optical bodies. More specifically, the invention is directed to optical bodies that resist warping when cycled through temperature changes, and to methods of making such optical bodies.

### BACKGROUND

Multilayer polymeric optical films are widely used for various purposes, including as mirrors and polarizers. These films often have extremely high reflectivity, while being lightweight and resistant to breakage. Thus, the films are well suited for use as reflectors and polarizers in compact electronic displays, including as liquid crystal displays (LCDs) placed in mobile telephones, personal data assistants, and portable computers.

Although polymeric optical films can have favorable optical and physical properties, one limitation with some such films is that they may show significant dimensional instability when exposed to fluctuations in temperature—even the temperature fluctuations experienced in normal use. This dimensional instability can result in formation of wrinkles in the film as it expands and contracts. Such dimensional instability is particularly common when temperatures approach or exceed approximately 80° C. At these temperatures the films fail to maintain a smooth, flat surface, and form wrinkles as a result of warping. In general, wrinkling is one common indicator of film warpage. This warping is often particularly pronounced in larger films, such as those used in desktop LCD monitors and notebook computers. Reflective polarizer film warping manifests itself in LCDs as rows of shadows. Warping is also observed when the film is cycled to high temperature and high humidity conditions, such as conditions of 60° C. and 70 percent relative humidity.

### SUMMARY OF THE INVENTION

The invention is directed to optical bodies and methods of making optical bodies and, in particular, to optical bodies having at least one warp-resistant layer disposed on an optical film.

One embodiment of the invention is an optical body that includes an optical film and at least one warp-resistant layer disposed on the optical film. The at least one warp-resistant layer includes a combination of i) polystyrene or a first polystyrene copolymer and ii) a second polystyrene copolymer. In one example, the first polystyrene copolymer is a styrene acrylonitrile copolymer.

Another embodiment of the invention is an optical body that includes an optical film and at least one warp-resistant layer disposed on the optical film. The at least one warp-resistant layer includes a norbornene-based polymer.

In another embodiment, a multilayer optical body is disclosed and includes a light reflecting element formed from a first polymer material and a second polymer material having an index of refraction difference sufficient to reflect light of at least one polarization, and at least one non-optical warp-resistant layer disposed on the light reflecting element. The at least one non-optical one warp-resistant layer includes an intimate mixture of i) polystyrene or a first polystyrene copolymer and ii) a second polystyrene copolymer or ii) a polyester or copolyester.

Yet other embodiments of the invention include methods of making an optical body. The methods include forming at least one of the warp-resistant layers described above on an optical film.

### BRIEF DESCRIPTION OF THE DRAWINGS

The invention will be further explained with reference to the drawings.

FIG. 1 is a side elevational view of an optical body constructed and arranged in accordance with a first implementation of the invention, showing an optical body with an optical film, a dimensionally stable layer, and an intermediate layer.

FIG. 2 is a side elevational view of an optical body constructed and arranged in accordance with a second implementation of the invention, showing an optical body without an intermediate layer.

FIG. 3 is a side elevational view of an optical body constructed and arranged in accordance with a third implementation of the invention, showing an optical body with two dimensionally stable layers.

FIG. 4 is a plan view of a system for forming an optical body in accordance with an implementation of the invention.

### DETAILED DESCRIPTION OF THE INVENTION

As stated above, the present invention provides an optical body that resists warping. Such warping occurs in some optical films, particularly polymeric optical films, including oriented polymeric optical films. The optical body contains an optical film, one or more dimensionally stable layers, and one or more optional additional layers. The optional additional layers can be an intermediate binding layer between the optical film and dimensionally stable layer.

The dimensionally stable layer assists the optical film to resist warping. In other words, warping of the optical film is reduced by use of a dimensionally stable layer with the optical film. The dimensionally stable layer is considered dimensionally stable because the dimensionally stable layer does not substantially warp under conditions, such as elevated temperature, elevated humidity, or both, that cause warpage of the optical film.

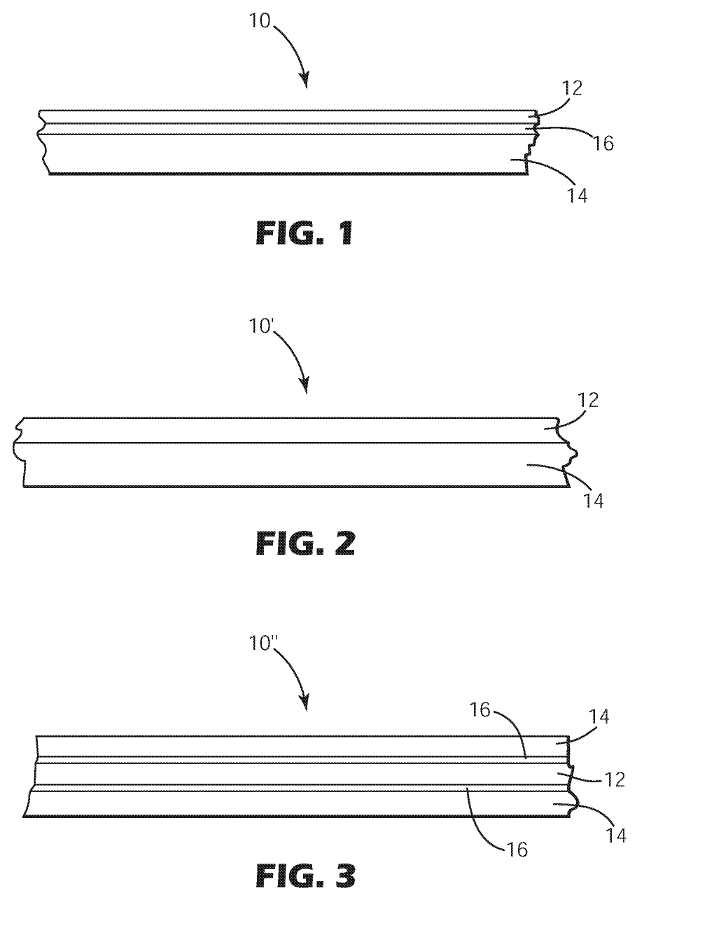

Reference is now made to FIGS. 1 through 3, which show various general embodiments of the invention. In FIG. 1, optical body 10 includes an optical film 12, a dimensionally stable layer 14, and an intermediate layer 16. The three layers in the example depicted in FIG. 1 show the thickest layer being the dimensionally stable layer 14, followed in thickness by the optical film 12 and the intermediate layer 16. However, the layers can be constructed to have different relative thicknesses than those shown in FIG. 1. Thus, the optical film 12 can optionally be of greater thickness than the dimensionally stable layer 14.

In FIG. 2, optical body 10′ includes optical film 12 and dimensionally stable layer 14, but does not further include a discrete intermediate layer. FIG. 3 shows a further implementation of the invention of an optical body 10″ with one optical film 12 and two dimensionally stable layers 14. Optical body 10″ also includes two intermediate layers 16. Other implementations of the invention, not shown in the figures, include optical bodies with two dimensionally stable layers but without intermediate layers.

These various components, along with methods of making the optical body of the invention, are described below.

Various optical films are suitable for use with the present invention. In particular, polymeric optical films, including oriented polymeric optical films, are suitable for use with the invention because they are prone to warpage from exposure to temperature fluctuations.

The optical films include multilayer optical films, including multilayer films (whether composed of all birefringent optical layers, some birefringent optical layers, or all isotropic optical layers) having a high reflectivity over a wide bandwidth, and continuous/disperse phase optical films. The optical films include polarizers and mirrors. In general, multilayer optical films are specular reflectors and continuous/disperse phase optical films are diffuse reflectors, although these characterizations are not universal (see, e.g., the diffuse multilayer reflective polarizers described in U.S. Pat. No. 5,867,316). These optical films are merely illustrative and are not meant to be an exhaustive list of suitable polymeric optical films useful with the present invention.

Both multilayer reflective optical films and continuous/disperse phase reflective optical films rely on index of refraction differences between at least two different materials (preferably polymers) to selectively reflect light of at least one polarization orientation. Suitable diffuse reflective polarizers include the continuous/disperse phase optical films described in U.S. Pat. No. 5,825,543, incorporated herein by reference, as well as the diffusely reflecting optical films described in U.S. Pat. No. 5,867,316, incorporated herein by reference.

Optical films that are especially suitable for use in the present invention are multilayer reflective films such as those described in, for example, U.S. Pat. Nos. 5,882,774 and 6,352,761 and in PCT Publication Nos. WO95/17303; WO95/17691; WO95/17692; WO95/17699; WO96/19347; and WO99/36262, all of which are incorporated herein by reference. The film is preferably a multilayer stack of polymer layers with a Brewster angle (the angle at which reflectance of p polarized light goes to zero) that is very large or nonexistent. The film is made into a multilayer mirror or polarizer whose reflectivity for p polarized light decreases slowly with angle of incidence, is independent of angle of incidence, or increases with angle of incidence away from the normal. Commercially available forms of such multilayer reflective polarizers are marketed as Dual Brightness Enhanced Film (DBEF) by 3M, St. Paul, Minn. Multilayer reflective optical films are used herein as an example to illustrate optical film structures and methods of making and using the optical films of the invention. The structures, methods, and techniques described herein can be adapted and applied to other types of suitable optical films.

A suitable multilayer reflective optical film can be made by alternating (e.g., interleaving) uniaxially- or biaxially-oriented birefringent first optical layers with second optical layers. In some embodiments, the second optical layers have an isotropic index of refraction that is approximately equal to one of the in-plane indices of the oriented layer. The interface between the two different optical layers forms a light reflection plane. Light polarized in a plane parallel to the direction in which the indices of refraction of the two layers are approximately equal will be substantially transmitted. Light polarized in a plane parallel to the direction in which the two layers have different indices will be at least partially reflected. The reflectivity can be increased by increasing the number of layers or by increasing the difference in the indices of refraction between the first and second layers. Generally, multilayer optical films have about 2 to 5000 optical layers, typically about 25 to 2000 optical layers, and often about 50 to 1500 optical layers or about 75 to 1000 optical layers. A film having a plurality of layers can include layers with different optical thicknesses to increase the reflectivity of the film over a range of wavelengths. For example, a film can include pairs of layers which are individually tuned (for normally incident light, for example) to achieve optimal reflection of light having particular wavelengths. It should further be appreciated that, although only a single multilayer stack may be described, the multilayer optical film can be made from multiple stacks that are subsequently combined to form the film. The described multilayer optical films can be made according to U.S. Ser. No. 09/229,724 and U.S. Patent Application Publication No. 2001/0013668, which are both incorporated herein by reference.

A polarizer can be made by combining a uniaxially-oriented first optical layer with a second optical layer having an isotropic index of refraction that is approximately equal to one of the in-plane indices of the oriented layer. Alternatively, both optical layers are formed from birefringent polymers and are oriented in a multiple draw process so that the indices of refraction in a single in-plane direction are approximately equal. The interface between the two optical layers forms a light reflection plane for one polarization of light. Light polarized in a plane parallel to the direction in which the indices of refraction of the two layers are approximately equal will be substantially transmitted. Light polarized in a plane parallel to the direction in which the two layers have different indices will be at least partially reflected. For polarizers having second optical layers with isotropic indices of refraction or low in-plane birefringence (e.g., no more than about 0.07), the in-plane indices (nₓ and n_{y}) of refraction of the second optical layers are approximately equal to one in-plane index (e.g., n_{y}) of the first optical layers. Thus, the in-plane birefringence of the first optical layers is an indicator of the reflectivity of the multilayer optical film. Typically, it is found that the higher the in-plane birefringence, the better the reflectivity of the multilayer optical film. If the out-of-plane indices (n_{z}) of refraction of the first and second optical layers are equal or nearly equal (e.g., no more than 0.1 difference and preferably no more than 0.05 difference), the multilayer optical film also has less off-angle color. Off-angle color arises from non-uniform transmission of light at angles other than normal to the plane of the multilayer optical film.

A mirror can be made using at least one uniaxially birefringent material, in which two indices (typically along the x and y axes, or nₓ and n_{y}) are approximately equal, and different from the third index (typically along the z axis, or n_{z}). The x and y axes are defined as the in-plane axes, in that they represent the plane of a given layer within the multilayer film, and the respective indices nₓ and n_{y} are referred to as the in-plane indices. One method of creating a uniaxially birefringent system is to biaxially orient (stretch along two axes) the multilayer polymeric film. If the adjoining layers have different stress-induced birefringence, biaxial orientation of the multilayer film results in differences between refractive indices of adjoining layers for planes parallel to both axes, resulting in the reflection of light of both planes of polarization. A uniaxially birefringent material can have either positive or negative uniaxial birefringence. Positive uniaxial birefringence occurs when the index of refraction in the z direction (n_{z}) is greater than the in-plane indices (nₓ and n_{y}). Negative uniaxial birefringence occurs when the index of refraction in the z direction (n_{z}) is less than the in-plane indices (nₓ and n_{y}). If n_{1z} is selected to match n₂ₓ=n_{2y}=n_{2z} and the multilayer film is biaxially oriented, there is no Brewster's angle for p-polarized light and thus there is constant reflectivity for all angles of incidence. Multilayer films that are oriented in two mutually perpendicular in-plane axes are capable of reflecting an extraordinarily high percentage of incident light depending of the number of layers, f-ratio, indices of refraction, etc., and are highly efficient mirrors. Mirrors can also be made using a combination of uniaxially-oriented layers with in-plane indices of refraction which differ significantly.

The first optical layers are preferably birefringent polymer layers that are uniaxially- or biaxially-oriented. The birefringent polymers of the first optical layers are typically selected to be capable of developing a large birefringence when stretched. Depending on the application, the birefringence may be developed between two orthogonal directions in the plane of the film, between one or more in-plane directions and the direction perpendicular to the film plane, or a combination of these. The first polymer should maintain birefringence after stretching, so that the desired optical properties are imparted to the finished film. The second optical layers can be polymer layers that are birefringent and uniaxially- or biaxially-oriented or the second optical layers can have an isotropic index of refraction which is different from at least one of the indices of refraction of the first optical layers after orientation. The second polymer advantageously develops little or no birefringence when stretched, or develops birefringence of the opposite sense (positive-negative or negative-positive), such that its film-plane refractive indices differ as much as possible from those of the first polymer in the finished film. For most applications, it is advantageous for neither the first polymer nor the second polymer to have any absorbance bands within the bandwidth of interest for the film in question. Thus, all incident light within the bandwidth is either reflected or transmitted. However, for some applications, it may be useful for one or both of the first and second polymers to absorb specific wavelengths, either totally or in part.

The first and second optical layers and the optional non-optical layers of the multilayer optical film are composed of polymers such as, for example, polyesters. The term “polymer” will be understood to include homopolymers and copolymers, as well as polymers or copolymers that may be formed in a miscible blend, for example, by coextrusion or by reaction, including, for example, transesterification. The terms “polymer”, “copolymer”, and “copolyester” include both random and block copolymers.

Polyesters for use in the multilayer optical films of the present invention generally include carboxylate and glycol subunits and are generated by reactions of carboxylate monomer molecules with glycol monomer molecules. Each carboxylate monomer molecule has two or more carboxylic acid or ester functional groups and each glycol monomer molecule has two or more hydroxy functional groups. The carboxylate monomer molecules may all be the same or there may be two or more different types of molecules. The same applies to the glycol monomer molecules. Also included within the term “polyester” are polycarbonates derived from the reaction of glycol monomer molecules with esters of carbonic acid.

Suitable carboxylate monomer molecules for use in forming the carboxylate subunits of the polyester layers include, for example, 2,6-naphthalene dicarboxylic acid and isomers thereof, terephthalic acid; isophthalic acid; phthalic acid; azelaic acid; adipic acid; sebacic acid; norbornene dicarboxylic acid; bi-cyclooctane dicarboxylic acid; 1,6-cyclohexane dicarboxylic acid and isomers thereof, t-butyl isophthalic acid, trimellitic acid, sodium sulfonated isophthalic acid; 2,2′-biphenyl dicarboxylic acid and isomers thereof, and lower alkyl esters of these acids, such as methyl or ethyl esters. The term “lower alkyl” refers, in this context, to C1-C10 straight-chained or branched alkyl groups.

Suitable glycol monomer molecules for use in forming glycol subunits of the polyester layers include ethylene glycol; propylene glycol; 1,4-butanediol and isomers thereof, 1,6-hexanediol; neopentyl glycol; polyethylene glycol; diethylene glycol; tricyclodecanediol; 1,4-cyclohexanedimethanol and isomers thereof; norbornanediol; bicyclo-octanediol; trimethylol propane; pentaerythritol; 1,4-benzenedimethanol and isomers thereof, bisphenol A; 1,8-dihydroxy biphenyl and isomers thereof, and 1,3-bis(2-hydroxyethoxy)benzene.

One polyester useful in the optical films of the present invention is polyethylene naphthalate (PEN), which can be made, for example, by reaction of naphthalene dicarboxylic acid with ethylene glycol. Polyethylene 2,6-naphthalate (PEN) is frequently chosen as a first polymer. PEN has a large positive stress optical coefficient, retains birefringence effectively after stretching, and has little or no absorbance within the visible range. PEN also has a large index of refraction in the isotropic state. Its refractive index for polarized incident light of 550 nm wavelength increases when the plane of polarization is parallel to the stretch direction from about 1.64 to as high as about 1.9. Increasing molecular orientation increases the birefringence of PEN. The molecular orientation may be increased by stretching the material to greater stretch ratios and holding other stretching conditions fixed. Other semicrystalline polyesters suitable as first polymers include, for example, polybutylene 2,6-naphthalate (PBN), polyethylene terephthalate (PET), and copolymers thereof.

Additional materials useful as first polymers are described, for example, in U.S. Pat. Nos. 6,352,762 and 6,498,683 and U.S. patent application Ser. Nos. 09/229,724, 09/232,332, 09/399,531, and 09/444,756, which are incorporated herein by reference. One polyester that is useful as a first polymer is a coPEN having carboxylate subunits derived from 90 mol % dimethyl naphthalene dicarboxylate and 10 mol % dimethyl terephthalate and glycol subunits derived from 100 mol % ethylene glycol subunits and an intrinsic viscosity (IV) of 0.48 dL/g. The index of refraction is approximately 1.63. The polymer is herein referred to as low melt PEN (90/10). Another useful first polymer is a PET having an intrinsic viscosity of 0.74 dL/g, available from Eastman Chemical Company (Kingsport, Tenn.). Non-polyester polymers are also useful in creating polarizer films. For example, polyether imides can be used with polyesters, such as PEN and coPEN, to generate a multilayer reflective mirror. Other polyester/non-polyester combinations, such as polyethylene terephthalate and polyethylene (e.g., those available under the trade designation Engage 8200 from Dow Chemical Corp., Midland, Mich.), can be used.

The second polymer should be chosen so that in the finished film, the refractive index, in at least one direction, differs significantly from the index of refraction of the first polymer in the same direction. Because polymeric materials are typically dispersive, that is, the refractive indices vary with wavelength, these conditions should be considered in terms of a particular spectral bandwidth of interest. It will be understood from the foregoing discussion that the choice of a second polymer is dependent not only on the intended application of the multilayer optical film in question, but also on the choice made for the first polymer, as well as processing conditions.

The second optical layers can be made from a variety of second polymers having glass transition temperatures compatible with that of the first polymer and having a refractive index similar to the isotropic refractive index of the first polymer. Examples of suitable polymers, other than the CoPEN polymers discussed above, include vinyl polymers and copolymers made from monomers such as vinyl naphthalenes, styrene, maleic anhydride, acrylates, and methacrylates. Examples of such polymers include polyacrylates, polymethacrylates, such as poly(methyl methacrylate) (PMMA), and isotactic or syndiotactic polystyrene. Other polymers include condensation polymers such as polysulfones, polyamides, polyurethanes, polyamic acids, and polyimides. In addition, the second optical layers can be formed from polymers and copolymers such as polyesters and polycarbonates.

Exemplary second polymers include homopolymers of polymethylmethacrylate (PMMA), such as those available from Ineos Acrylics, Inc., Wilmington, Del., under the trade designations CP71 and CP80, or polyethyl methacrylate (PEMA), which has a lower glass transition temperature than PMMA. Additional second polymers include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, Tex. under the trade designation Solef 1008.

Yet other second polymers include polyolefin copolymers such as poly(ethylene-co-octene) (PE-PO) available from Dow-Dupont Elastomers under the trade designation Engage 8200, poly(propylene-co-ethylene) (PPPE) available from Fina Oil and Chemical Co., Dallas, Tex., under the trade designation Z9470, and a copolymer of atatctic polypropylene (aPP) and isotatctic polypropylene (iPP) available from Huntsman Chemical Corp., Salt Lake City, Utah, under the trade designation Rexflex W111. Second optical layers can also be made from a functionalized polyolefin, such as linear low density polyethylene-g-maleic anhydride (LLDPE-g-MA) such as that available from E.I. duPont de Nemours & Co., Inc., Wilmington, Del., under the trade designation Bynel 4105.

Particularly preferred combinations of layers in the case of polarizers include PEN/co-PEN, polyethylene terephthalate (PET)/co-PEN, PEN/sPS, PET/sPS, PEN/Eastar, and PET/Eastar, where “co-PEN” refers to a copolymer or blend based upon naphthalene dicarboxylic acid (as described above) and Eastar is polycyclohexanedimethylene terephthalate commercially available from Eastman Chemical Co.

Particularly preferred combinations of layers in the case of mirrors include PET/PMMA or PET/coPMMA, PEN/PMMA or PEN/coPMMA, PET/ECDEL, PEN/ECDEL, PEN/sPS, PEN/THV, PEN/co-PET, and PET/sPS, where “co-PET” refers to a copolymer or blend based upon terephthalic acid (as described above), ECDEL is a thermoplastic polyester commercially available from Eastman Chemical Co., and THV is a fluoropolymer commercially available from 3M Co. PMMA refers to polymethyl methacrylate and PETG refers to a copolymer of PET employing a second glycol (usually cyclohexanedimethanol). sPS refers to syndiotactic polystyrene.

Other polymeric optical films are suitable for use with the invention. In particular, the invention is suited for use with polymeric films that show excessive warping upon exposure to temperature variation. The optical films are typically thin. Suitable films include films of varying thickness, but particularly films less than 15 mils (about 380 micrometers) thick, more typically less than 10 mils (about 250 micrometers) thick, and preferably less than 7 mils (about 180 micrometers) thick. During processing, the dimensionally stable layer is extrusion coated onto the optical film at temperatures exceeding 250° C. Therefore, the optical film preferably withstands exposure to temperatures greater than 250° C. The optical film also normally undergoes various bonding and rolling steps during processing, and therefore the film should be flexible.

In addition to the first and second optical layers, the multilayer reflective film of the present invention optionally includes one or more non-optical layers such as, for example, one or more skin layers or one or more interior non-optical layers, such as, for example, protective boundary layers between packets of optical layers. Non-optical layers can be used to give the multilayer film structure or to protect it from harm or damage during or after processing. For some applications, it may be desirable to include sacrificial protective skins, wherein the interfacial adhesion between the skin layer(s) and the optical stack is controlled so that the skin layers can be stripped from the optical stack before use. In addition, it is beneficial if these sacrificial skins have sufficient adhesion to the structural layers that they can be re-applied after inspection of the film.

Materials may be chosen for the non-optical layers that impart or improve properties such as, for example, tear resistance, puncture resistance, toughness, weatherability, and solvent resistance of the multilayer optical body. Typically, one or more of the non-optical layers are placed so that at least a portion of the light to be transmitted, polarized, or reflected by the first and second optical layers also travels through these layers (i.e., these layers are placed in the path of light which travels through or is reflected by the first and second optical layers). The non-optical layers typically do not substantially affect the reflective properties of the optical films over the wavelength region of interest. Properties of the non-optical layers such as crystallinity and shrinkage characteristics need to be considered along with the properties of the optical layers to give the film of the present invention that does not crack or wrinkle when laminated to severely curved substrates.

The non-optical layers may be of any appropriate material and can be the same as one of the materials used in the optical stack. Of course, it is important that the material chosen not have optical properties deleterious to those of the optical stack. The non-optical layers may be formed from a variety of polymers, such as polyesters, including any of the polymers used in the first and second optical layers. In some embodiments, the material selected for the non-optical layers is similar to or the same as the material selected for the second optical layers. The use of coPEN, coPET, or other copolymer material for skin layers reduces the splittiness (i.e., the breaking apart of a film due to strain-induced crystallinity and alignment of a majority of the polymer molecules in the direction of orientation) of the multilayer optical film. The coPEN of the non-optical layers typically orients very little when stretched under the conditions used to orient the first optical layers, and so there is little strain-induced crystallinity.

Preferably, the polymers of the first optical layers, the second optical layers, and the optional non-optical layers are chosen to have similar rheological properties (e.g., melt viscosities) so that they can be co-extruded without flow disturbances. Typically, the second optical layers, skin layers, and optional other non-optical layers have a glass transition temperature, T_{g}, that is either below or no greater than about 40° C. above the glass transition temperature of the first optical layers. Preferably, the glass transition temperature of the second optical layers, skin layers, and optional non-optical layers is below the glass transition temperature of the first optical layers. When length orientation (LO) rollers are used to orient the multilayer optical film, it may not be possible to use desired low T_{g} skin materials, because the low T_{g} material will stick to the rollers. If LO rollers are not used, then this limitation is not an issue. For some applications, preferred skin layer materials include PMMA and polycarbonate because of their durability and their ability to protect the optical stack from UV radiation.

The thickness of the skin layers and optional non-optical layers is generally at least four times, typically at least 10 times, and can be at least 100 times, the thickness of at least one of the individual first and second optical layers. The thickness of the non-optical layers can be varied to make a multilayer reflective film having a particular thickness.

Additional coatings may also be considered non-optical layers. Other layers include, for example, antistatic coatings or films; flame retardants; UV stabilizers; abrasion resistant or hardcoat materials; optical coatings; anti-fogging materials, etc. Additional functional layers or coatings are described, for example, in U.S. Pat. No. 6,352,761 and WO 97/01440, WO 99/36262, and WO 99/36248, which are incorporated herein by reference. These functional components may be incorporated into one or more skin layers, or they may be applied as a separate film or coating.

The dimensionally stable layer provides resistance to warping of the optical film, while typically producing a flexible optical body that is not fragile. Examples of dimensionally stable layers and information about these layers can be found at U.S. patent application Ser. No. 09/698,717, incorporated herein by reference. The dimensionally stable layer is typically sufficiently flexible such that the optical body can be bent or rolled, yet still provides sufficient stability to avoid warping. In this regard, the dimensionally stable layer resists forming wrinkles and waves in the optical body, while still allowing easy handling and storage of the optical body, such as by being retained on a roll.

Although the composite optical body avoids warping, extreme temperature ranges, particularly high temperatures, can result in deterioration of the optical body. The dimensionally stable layer typically permits an optical film to be repeatedly cycled through a temperature of −30° C. to 85° C. every 1.5 hours for 400 hours without warping, or only insignificant warping. In contrast, the optical film alone without the dimensionally stable layer shows warping under these same circumstances. In addition, the optical film alone without the dimensionally stable layer exhibits warping when repeatedly cycled from room temperature to 60° C. and 70 percent relative humidity. These cycling tests are designed to be indicative of long term stability under expected use conditions in an LCD display or other device.

The dimensionally stable layer is normally transparent or substantially transparent. In implementations where high reflectivity of the optical body is desired, it is particularly important that exposed dimensionally stable layers be highly transparent. In addition, in order to avoid undesirable light shifts, the index of refraction of the dimensionally stable layer can be made such that it is close to the index of refraction of the optical film (or of any intermediate layers).

The polymer composition of the dimensionally stable layer is preferably selected such that it can be extruded, remains transparent after processing at high temperatures, and is substantially stable at temperatures from at least about −30° C. to 85° C. The dimensionally stable layer is normally flexible, but does not significantly expand in length or width over the temperature range of −30° C. to 85° C. To the extent that the dimensionally stable layer does expand over this temperature range, the expansion is substantially uniform such that the film does not show excessive wrinkling.

The dimensionally stable layer typically includes, as a primary component, a polymeric material exhibiting a glass transition temperature (T_{g}) from 85 to 200° C., more typically from 100 to 160° C. The thickness of the dimensionally stabile layer can vary depending upon the application. However, the dimensionally stable layer is typically from 0.1 to 10 mils (about 2 to 250 micrometers) thick, more typically from 0.5 to 8 mils (about 12 to 200 micrometers) thick, and even more typically from 1 to 7 mils (about 25 to 180 micrometers) thick.

Suitable dimensionally stable layers can include a combination (such as a blend or other intimate mixture) of at least i) polystyrene (for example, syndiotactic polystyrene) or a polystyrene copolymer and ii) another polystyrene copolymer. Generally, these particular polymers are present in an intimate mixture and not as individual particles disposed in the other polymer. In some embodiments, the dimensionally stable layer includes i) a first polystyrene copolymer and ii) a second polystyrene copolymer. The dimensionally stable layer can optionally include additional polystyrene copolymers. It will be understood that the term “copolymer” includes polymers having two or more different monomeric units.

One particularly suitable example of a dimensionally stable layer includes i) styrene acrylonitrile (SAN) copolymer and ii) a second styrene copolymer. Examples of suitable comonomers for styrene copolymers include butadiene, methyl methacrylate, iso-octyl acrylate, methacrylic acid, maleic anhydride, n-phenyl maleimide, as well as similar material including other acrylates, methacrylates, and dienes. Suitable styrene copolymers for use with SAN include, for example, acrylonitrile butadiene styrene (ABS) copolymers, styrene butadiene (SB) copolymers, acrylic styrene acrylonitrile (ASA) copolymers, styrene methyl methacrylate (SMM) copolymers, and other styrene copolymers such as the Kraton™ copolymers available from Kraton Polymers, Houston, Tex. In particular, the SAN/ABS combination has been found to be particularly useful. Typically, the second styrene copolymer is present within the dimensionally stable layers at a level of approximately 1 to 45 weight percent based on the total amount of material in the dimensionally stable layer, more typically at 3 to 30 weight percent.

In another example, the dimensionally stable layer includes i) polystyrene (e.g., syndiotactic polystyrene) and ii) styrene acrylonitrile copolymer. In at least one embodiment, the SAN copolymer is the primary component and the polystyrene is provided at a level of 1 to 45 weight percent based on the total amount of material in the dimensionally stable layer, more typically at 3 to 30 weight percent.

The dimensionally stable layer can also include other materials blended with the styrene components described above. For example, coPEN or coPET can be used in the dimensionally stable layer, preferably, at low levels. CoPEN or coPET can, at least in some embodiments, phase separate within the mixture to form domains within the styrene-based polymer/copolymer or copolymer/copolymer combinations described above. The addition of coPEN and coPET can, in at least some embodiments, provide light diffusion. In addition, in at least some embodiments the coPEN or coPET can aid in the adhesion of the dimensionally stable layer to optical films that contain coPEN or coPET. Optionally, coPEN and coPET can be used as the intermediate layer in order to increase diffusion as well as to help retain the layers together. Typically, coPEN or coPET can be used in the dimensionally stable layers at levels of approximately 1 to 30 weight percent of the material of the dimensionally stable layer, more typically at 3 to 20 weight percent, and, in some embodiments, at 3 to 10 weight percent. Surprisingly, it has been found that blending of materials, such as coPEN or coPET, with lower Tg and lower modulus than the polystyrene or polystyrene copolymer into the dimensionally stable layer will improve the film's resistance to permanent warping. For example, blending coPEN's of lower modulus and lower Tg into dimensionally stable layers comprising SAN have substantially reduced the amount of warpage measured in these films.

The coPEN and coPET copolymers can optionally include comonomers useful for increasing the glass transition temperature such as norbornene or tertiary butyl isophthalic acid. Other high Tg materials useful for blending into the dimensionally stable layer include polycarbonate and polyetherimides such as Ultem™ from by General Electric. These high Tg materials can be used at the same levels as coPEN and coPET.

Other materials that can be used in the dimensionally stable layer include elastomeric components such as butadiene, ethylene propylene terpolymers (such as, for example, ethylene propylene dimethacrylate), modified polyolefins such as Admer™ polymers from Mitsui Chemicals America, Inc. (Mitsui Chemicals), Purchase, N.Y. or Bynel™ polymers from E.I. Dupont de Nemours Corp. (Dupont), Wilmington, Del. or rubber-like particles. These elastomeric components can be incorporated into the dimensionally stable layer to enhance diffusivity, toughness, durability, or any combination of these properties. Typically, the elastomeric component can be used in the dimensionally stable layers at levels of approximately 1 to 30 weight percent of the material of the dimensionally stable layer, more typically at 3 to 10 weight percent.

Another material that can be added to the dimensionally stable layer is an anti-static material. Suitable anti-static materials include, for example, polyether copolymers (such as, for example, polyethylene glycol), Irgastat™ P18 from Ciba Specialty Chemicals, LR-92967 from Ampacet, Tarrytown, N.Y., Pelestat™ NC6321 and Pelestat™ NC7530 from Tomen America Inc., New York, N.Y., and ionic polymers, such as, for example, the static dissipative polymer blends (e.g., Stat-Rite™ polymer products) manufactured by Noveon, Inc., Cleveland, Ohio. Typically, the anti-static material can be used at levels of approximately 10 to 30 weight percent of the material of the dimensionally stable layer, more typically at 10 to 20 weight percent.

The dimensionally stable layer can be formed such that it diffuses light. The diffusion property can be accomplished by using an inherently diffuse polymeric material or by embossing a diffuse pattern onto the dimensionally stable layer during manufacture. The embossed pattern can also re-direct light from angles far from normal to the film towards angles which are closer to normal from the film. Diffusion in the dimensionally stable layer can also be accomplished by incorporation of small particles with refractive indices differing from that of the dimensionally stable layer.

The roughened surface formed by the addition of particles to the dimensionally stable layer can lower the film's coefficient of friction thus reducing the film's tendency to adhere to adjacent surfaces such as glass or other rigid films. Reducing the film's adherence to adjacent surfaces removes or reduces the impact of an additional constraint (e.g., an adjacent glass or film surface) on the film that would otherwise contribute to film warpage.

The dimensionally stable layer can be coated with one or more additional coatings to provide additional properties. Examples of such coatings include anti-static coatings, flame retardants, UV stabilizers, abrasion resistant or hardcoat materials, optical coatings, and anti-fogging coatings.

One or more strippable skin layers can also be provided over the dimensionally stable layer or layers. These strippable skin layers can be used to protect the underlying optical body during storage and shipping. The strippable skin layers are typically removed prior to use of the optical body. The strippable skin layers can be disposed onto the dimensionally stable layer by coating, extrusion, or other suitable methods or can be formed by coextrusion or other suitable methods with the dimensionally stable layer. The strippable skin layer can be adhered to the optical body using an adhesive, although in some embodiments, no adhesive is necessary. The strippable skin layers can be formed using any protective polymer material than has sufficient adherence (with or without adhesive as desired) to the dimensionally stable layer so that the strippable skin layer will remain in place until the strippable skin layer is removed manually or mechanically. Suitable materials include, for example, low melting and low crystallinity polyolefins such as copolymers of syndiotactic polyrpropylene (for example, Finaplas 1571 from Atofina), copolymers of propylene and ethylene (for example, PP8650 from Atofina), or ethylene octene copolymers (for example, Affinity PT 1451 from Dow). Optionally, a mixture of polyolefin materials can be utilized for the strippable skin layer. Preferably, the strippable skin material has a melting point of 80° C. to 145° C. according to differential scanning calorimetry (DSC) measurement, more preferably a melting point of 90° C. to 135° C. The skin layer resin typically has a melt flow index of 7 to 18 g/10 minutes, preferably 10 to 14 g/10 minutes as measured according to ASTM D1238-95 (“Flow Rates of Thermoplastics by Extrusion Plastometer”), incorporated herein by reference, at a temperature of 230° C. and a force of 21.6 N.

Preferably, when the strippable skin layer is removed there will be no remaining material from the strippable skin layer or any associated adhesive, if used. The strippable skin layer typically has a thickness of at least 12 micrometers. Optionally, the strippable skin layer includes a dye, pigment, or other coloring material so that it is easy to observe whether the strippable skin layer is on the optical body or not. This can facilitate proper use of the optical body. In some embodiments, the strippable skin layer can also include particles disposed in the strippable skin layer that are sufficiently large (for example, at least 0.1 micrometers) that can be used to emboss the underlying dimensionally stable layer by application of pressure to the optical body with the strippable skin layer. Other materials can be blended into the strippable skin layer to improve adhesion to the dimensionally stable layers. Modified polyolefins containing vinyl acetate or maleic anhydride may be particularly useful for improving adhesion of the strippable skin layers to the dimensionally stable layers.

Instead of using polystyrene or polystyrene copolymers, the dimensionally stable layer can include norbornene-based polymers such as, for example, copolymers of ethylene and norbornene such as Topas™ polymers available from Ticona, Summit, N.J. and Zeonor™ polymers available from Zeon Chemicals, Louisville, Ky. It has been found particularly useful that different grades of these copolymers having high and low Tg's can be blended to adjust the composite Tg to allow orientation of the dimensionally stable layer with the optical layers. The materials described above for addition to the polystyrene or polystyrene copolymers, as well as the strippable skins, can also be used with the norbornene-based polymers.

The dimensionally stable layer is typically added to both sides of the optical film. However, in some implementations the dimensionally stable layer is added to just one side of the optical film in order to encourage curling of the film, such as for making an optical body that will wrap around a fluorescent light tube.

The optical body can also optionally include one or more layers in addition to the optical film and the dimensionally stable layer or layers. When one or more additional layers are present, they typically function to improve the integrity of the composite optical body. In particular, the layers can serve to bind the optical film to the dimensionally stable layer. In certain implementations the dimensionally stable layer and the optical film will not form a strong bond directly to one another. In such implementations, an intermediate layer to adhere them together is necessary.

The composition of the intermediate layers is typically chosen in order to be compatible with the optical film and the dimensionally stable layer that they contact. The intermediate layers should bind well to both the optical film and the dimensionally stable layer. Therefore, the choice of the material used in the intermediate layer will often vary depending upon the composition of the other components of the optical body.

In specific implementations the intermediate layer is an extrudable transparent hot melt adhesive. Such layers can include coPENs containing one or more of naphthalene dicarboxylic acid (NDC), dimethyl terepthalate (DMT), hexane diol (HD), trimethylol propane (TMP), and ethylene glycol (EG). Layers that contain NDC are particularly well suited to adhering to the dimensionally stable layer to optical films containing PEN or CoPEN or both. In such implementations, the coPEN of the intermediate layer typically contains from 20 to 80 parts NDC, preferably 30 to 70 parts NDC, and more preferably 40 to 60 parts NDC, per 100 parts of the carboxylate component of the coPEN.

Various additional compounds can be added, including the comonomers previously listed in the optical film. Extrusion aids such as plasticizers and lubricants can be added for improved processing and adhesion to other layers. Also, particles such as inorganic spheres or polymer beads with a different refractive index from the adhesive polymer can be used.

Other materials useful for intermediate layers include polyolefins modified with vinyl acetate such as Elvax™ polymers from Dupont and polyolefins modified with maleic anhydride such as Bynel™ polymers from Dupont and Admer™ polymers from Mitsui Chemicals.

In certain implementations, an intermediate layer is integrally formed with the optical film, the dimensionally stable layer, or both. The intermediate layer can be integrally formed with the optical film by being a skin coat on the exposed surfaces of the optical film. The skin coat typically is formed by co-extrusion with the optical film to integrally form and bind the layers. Such skin coats are selected so as to improve the ability to bind subsequent layers to the optical film. Skin coats are particularly useful when the optical film would otherwise have a very low affinity to the specific dimensionally stable layer that is being used. Similarly, an intermediate layer can be integrally formed with the dimensionally stable layer by being simultaneously co-extruded or sequentially extruded onto the optical film. In yet other implementations of the invention, a skin layer can be formed on the optical film and another intermediate layer can be formed with the dimensionally stable layer.

The intermediate layer or layers are preferably thermally stable in a melt phase at temperatures above 250° C. Thus, the intermediate layer does not substantially degrade during extrusion at temperatures greater than 250° C. The intermediate layer is normally transparent or substantially transparent so as to avoid reducing the optical properties of the film. The intermediate layer is typically less than 2 mils (about 50 micrometers) thick, more typically less than 1 mil (about 25 micrometers) thick, and even more typically less than about 0.5 mil (about 12 micrometers) thick. The thickness of the intermediate layer is preferably minimized in order to maintain a thin optical body.

Various methods may be used for forming the composite optical body of the present invention. As stated above, the optical bodies can take on various configurations, and thus the methods vary depending upon the configuration of the final optical body.

A step common to all methods of forming the composite optical body is adhering the optical film to the dimensionally stable layer or layers. This step can be conducted in a variety of ways, such as co-extruding various layers, extrusion coating the layers, or co-extrusion coating of the layers (such as when a dimensionally stable layer and an intermediate layer are simultaneously extrusion coated onto the optical film).

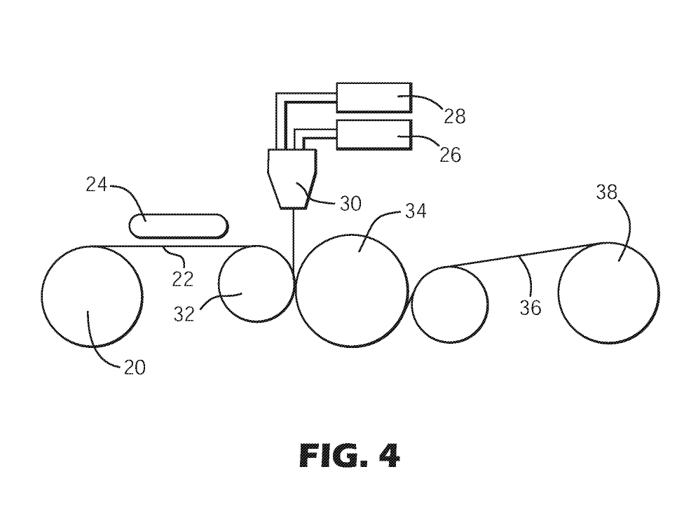

FIG. 4 shows a plan view of a system for forming an optical body in accordance with one implementation of the invention. Spool 20 containing optical film 22 is unwound and heated at infrared heating station 24. Optical film 22 is normally raised to a temperature above 50° C., and more commonly to a temperature of approximately 65° C. Composition 26 for forming a dimensionally stable layer and composition 28 for forming an intermediate adhesive layer are fed through feed block 30 and coextrusion coated onto the preheated optical film 22. Thereafter, the optical film is pressed between rolls 32, 34. Roll 32 or roll 34 or both optionally contain a matte-finish to impart a slightly diffuse surface on the dimensionally stable layer. After cooling, the coated optical film 36 can be subsequently processed, such as by cutting into sheets, to form a finished optical body that is rolled onto winder 38.

The extruded film can be oriented by stretching individual sheets of the optical body material in heated air. For economical production, stretching may be accomplished on a continuous basis in a standard length orienter, tenter oven, or both. Economies of scale and line speeds of standard polymer film production may be achieved thereby achieving manufacturing costs that are substantially lower than costs associated with commercially available absorptive polarizers.

To make a mirror, two uniaxially stretched polarizing sheets are positioned with their respective orientation axes rotated 90° C., or the sheet is biaxially stretched. Biaxially stretching the multilayered sheet will result in differences between refractive indices of adjoining layers for planes parallel to both axes thereby resulting in reflection of light in both planes of polarization directions.

One method of creating a birefringent system is to biaxially stretch (e.g., stretch along two dimensions) a multilayer stack in which at least one of the materials in the stack has its index of refraction affected by the stretching process (e.g., the index either increases or decreases). Biaxial stretching of the multilayer stack may result in differences between refractive indices of adjoining layers for planes parallel to both axes thus resulting in reflection of light in both planes of polarization. Specific methods and materials are taught in PCT patent application WO 99/36812 entitled “An Optical Film and Process for Manufacture Thereof”, incorporated herein by reference in its entirety.

The pre-stretch temperature, stretch temperature, stretch rate, stretch ratio, heat set temperature, heat set time, heat set relaxation, and cross-stretch relaxation are selected to yield a multilayer device having the desired refractive index relationship. These variables are inter-dependent; thus, for example, a relatively low stretch rate could be used if coupled with, e.g., a relatively low stretch temperature. It will be apparent to one of ordinary skill how to select the appropriate combination of these variables to achieve the desired multilayer device. In general, however, a stretch ratios in the range from 1:2 to 1:10 (more preferably 1:3 to 1:7) in the stretch direction and from 1:0.5 to 1:10 (more preferably from 1:0.5 to 1:7) orthogonal to the stretch direction is preferred.

### EXAMPLE

A multi-layer reflective polarizer was constructed with first optical layers comprising PEN (polyethylene naphthalate) and second optical layers comprising coPEN (copolyethylene naphthalate). The PEN and coPEN were coextruded through a multi-layer melt manifold and multiplier to form 825 alternating first and second optical layers. This multi-layer film also contained two internal and two external protective boundary layers of the same coPEN as the second optical layers for a total of 829 layers. In addition, two external skin layers were coextruded on both sides the optical layer stack. The dimensionally stable layers were about 18 micrometers thick and comprised 94 wt. % SAN (Tyril 880 from Dow Corporation) and 6 wt. % ABS. Strippable skin layers of syndiotactic polypropylene (PP1571 from Atofina) were formed over the SAN layers. An extruded cast web of the above construction was then heated in a tentering oven with air at 150° C. for 45 seconds and then uniaxially oriented at a 6:1 draw ratio. Warp testing indicated that the optical body with the SAN/ABS dimensionally stable layers had significantly better warp resistance than a similar optical body with no dimensionally stable layers and better warp resistance than a similar optical body with dimensionally stable layers made using SAN alone. In addition, the SAN/ABS dimensionally stable layers provided at least as good warp resistance, if not better, when compared to an optical film with dimensionally stable layers having SAN and 5 wt. % coPEN or coPET.

One example of a method for observing warp is as follows: Clean two 9.5″×12.5″ (24.1×31.8 cm) flat pieces of double strength glass with isopropyl alcohol. A 9″×12″ (22.9×30.5 cm) piece of the optical body is attached to one piece of glass on two short sides and one of the long sides, leaving the remaining long side unconstrained. To attach the optical body, first attach Double Stick Tape (3M, St. Paul, Minn.) to a piece of glass such that the tape is 0.5″ (1.3 cm) from three edges of the glass and will be exactly covered by 3 sides of the optical body. Avoid overlapping the ends of the tape. Place the optical body on the tape such that the optical body is tensioned across the tape and is held above the glass surface by the thickness of the tape (about 0.1 mm). Roll the optical body down to the tape with a 4.5 lb. (2 kg) roller once in each direction, avoiding extra force.

Place three 0.1 mm thick, 0.5″ (1.3 cm) wide polyethylene terephthalate (PET) shims onto the rolled optical body, the shims being exactly above the tape and of the same lengths, but on the opposite side of the optical body. Avoid overlapping the shims. Place the top piece of glass on top of the shims and exactly aligned with the bottom piece of glass.

This completes a sandwiched construction of glass-tape-optical film-shim-glass, in which the optical body is constrained at three edges and substantially free floating in the center. This construction is attached together with 4 binder clips as are commonly used to hold stacks of paper together (Binder Clips, Officemate International Corporation, Edison, N.J.). The clips should be of an appropriate size to apply pressure to the center of the tape (approximately 0.75″ (1.9 cm) from the edge of the glass) and are positioned two each on the short sides of the construction, each about 0.75″ (1.9 cm) away from the bottom and top of the optical body.

This completed construction is placed in a thermal shock chamber (Model SV4-2-2-15 Environmental Test Chamber, Envirotronics, Inc., Grand Rapids, Mich.) and subjected to 96 cycles, a cycle consisting of one hour at 85° C. followed by one hour at −35° C. The film is then removed from the chamber and inspected for wrinkles. Warpage is considered unacceptable when there are many deep wrinkles across the surface of the film. When there are few shallow wrinkles or the film appears smooth, warpage is generally considered acceptable.

Although the present invention has been described with reference to preferred embodiments, those of skill in the art will recognize that changes may be made in form and detail without departing from the spirit and scope of the invention.

1. An optical body, comprising:
a light reflecting element comprising a first polymer material and a second polymer material having an index of refraction difference sufficient to reflect light of at least one polarization; and
at least one non-optical warp-resistant layer disposed on the light reflecting element, the at least one non-optical one warp-resistant layer comprising an intimate mixture of i) polystyrene or a first polystyrene copolymer and ii) a second polystyrene copolymer.

2. The optical body of claim 1, wherein the optical body comprises at least two non-optical warp-resistant layers disposed with one of the non-optical warp-resistant layers disposed on each of two opposing sides of the light reflecting element.

3. The optical body of claim 1, wherein the at least one warp-resistant layer comprises i) a first polystyrene copolymer and ii) a second polystyrene copolymer.

4. The optical body of claim 3, wherein the first polystyrene copolymer is styrene acrylonitrile copolymer.

5. The optical body of claim 4, wherein the second polystyrene copolymer is selected from acrylonitrile butadiene styrene copolymers, styrene butadiene copolymers, acrylic styrene acrylonitrile copolymers, and styrene methyl methacrylate copolymers.

6. The optical body of claim 3, wherein the second polystyrene copolymer is provided in an amount of 3 to 30 wt. % based on the total weight of the non-optical warp-resistant layer.

7. The optical body of claim 1, wherein the non-optical warp-resistant layer further comprises a material selected from coPEN or coPET.

8. The optical body of claim 3, wherein the second polystyrene copolymer is acrylonitrile butadiene styrene copolymer.

9. The optical body of claim 1, wherein the optical film is a multilayer, polymeric optical film wherein the first polymer material forms a plurality of first optical layers and the second polymer material forms a plurality of second optical layers.

10. The optical body of claim 1, further comprising at least one strippable skin layer disposed over the at least one non-optical warp-resistant layer and the at least one strippable skin layer comprises a polyolefin.

11. The optical body of claim 10, wherein the polyolefin is selected from syndiotactic polypropylene, ethylene octene copolymers, copolymers of polypropylene/polyethylene, and blends thereof.

12. An optical body, comprising:
a light reflecting element comprising a first polymer material and a second polymer material having an index of refraction difference sufficient to reflect light of at least one polarization; and
at least one non-optical warp-resistant layer disposed on the light reflecting element, the at least one non-optical one warp-resistant layer comprising an intimate mixture of i) polystyrene or a polystyrene copolymer and ii) a polyester or copolyester.

13. The optical body of claim 12, wherein the optical body comprises at least two non-optical warp-resistant layers disposed with one of the non-optical warp-resistant layers disposed on each of two opposing sides of the light reflecting element.

14. The optical body of claim 12, wherein the at least one warp-resistant layer comprises i) a polystyrene copolymer and ii) a copolyester.

15. The optical body of claim 14, wherein the polystyrene copolymer is styrene acrylonitrile copolymer.

16. The optical body of claim 15, wherein the copolyester is a co-polyethylene naphthalate or a co-polyethylene terephthalate.

17. The optical body of claim 16, wherein the co-polyethylene naphthalate or co-polyethylene terephthalate has a lower glass transition temperature than the polystyrene copolymer.

18. The optical body of claim 12, wherein the optical film is a multilayer, polymeric optical film wherein the first polymer material forms a plurality of first optical layers and the second polymer material forms a plurality of second optical layers.

19. The optical body of claim 12, further comprising at least one strippable skin layer disposed over the at least one non-optical warp-resistant layer and the at least one strippable skin layer comprises a polyolefin.

20. The optical body of claim 12, wherein the polyester or copolyester is provided in an amount of 1 to 30 wt. % based on the total weight of the non-optical warp-resistant layer.
